(19) United States
(12) Patent Application Publication
(10) Pub. No.: US 2020/0220961 A1
(43) Pub. Date: Jul. 9, 2020

(54) Cleaning Device for Mobile Phone Screen

(71) Applicant: Chung Man LAW, Hong Kong (HK)

(72) Inventor: Chung Man LAW, Hong Kong (HK)

(21) Appl. No.: 16/281,068

(22) Filed: Feb. 20, 2019

(30) Foreign Application Priority Data
Jan. 9, 2019 (CN) 201910020506.1

(51) Int. Cl. H04M 1/17; B08B 1/00; B08B 11/04; B08B 3/02; B05C 13/02

(52) U.S. Cl. CPC H04M 1/17; B08B 1/006; B08B 13/00; B08B 3/02; B05C 13/02; B08B 11/04

(57) ABSTRACT

The invention relates to mobile phone peripheral devices, and discloses a cleaning device for a mobile phone screen which includes a frame. The frame is fixedly connected with a bracket, and a top end of the bracket is fixedly connected with a bearing sleeve. The inside of the bearing sleeve is rotatably connected with a rotating shaft. One end of the rotating shaft is fixedly connected with a rotating knob. One end of the rotating shaft is fixedly connected with a bevel gear. The inner of the bevel gear is fixedly sleeved with a threaded rod. Two ends of the threaded rod are rotationally connected with a bearing block. The surface of the threaded rod is fixedly connected to the limiting block. The cleaning device for the mobile phone screen is provided with a rotary knob and a bevel gear, and the rotary knob is rotated to drive the bevel gear so that the supporting plate can moves up and down. The position between the supporting plate and the cleaning sheet is located in accordance with the different thickness of the mobile phone, and the transmission is stable and precise. And it is possible to clean the screens of different sizes of mobile phones, thereby achieving a wide range of applications.

### FIELD OF THE INVENTION

The invention relates to the technical field of mobile phone peripheral devices, in particular to a cleaning device for mobile phone screen.

### BACKGROUND

Today's large-screen smartphones have become popular in people's daily lives, and are also an indispensable electronic device that is frequently used in people's lives. Due to the frequent use of large-screen smart phones, they phones often contact human fingers, faces and other parts, which are inevitably contaminated with dust, grease, bacteria and other dirt. If it is worse, it may even endanger the health of users. The traditional manual cleaning of the mobile phone screen is to spray the cleaning liquid on the screen of the mobile phone, and then wipe it with a cleaning cloth. If the screen of the mobile phone with more dirt is encountered, it may have to be repeated several times to clean the screen of the mobile phone, so the manual cleaning for the phone screen is inefficient.

At present, mobile phones are an indispensable communication tool for people, and their use is quite common. However, according to the digital newspaper of Zhenhai today published on May 9, 2012, mobile phones accumulate a certain amount of bacteria, and most bacteria are not harmful. But the more colonies, the greater the probability of carrying germs, and may also harm people's health. Therefore, we have developed a cleaning device for the screen of the mobile phone to solve the above problem.

### SUMMARY OF THE INVENTION

The technical problem to be solved is to overcome the above-mentioned deficiency by providing a cleaning device for mobile phone screen, with the advantages of wide application and easy replacement, which solves the problem of poor effect of existing cleaning devices.

In order to achieve the above-mentioned wide application and easy replacement, the present invention provides the following technical solution: a cleaning device for a mobile phone screen includes a frame. The inner side of the frame is fixedly connected with a bracket. The top end of the bracket is fixedly connected with a bearing sleeve. The inner side of the bearing sleeve is rotatably connected with a rotating shaft, and one end of the rotating shaft is fixedly connected with a rotary knob. One end of the rotating shaft is fixedly connected with a bevel gear. The inner side of the bevel bear is fixedly sleeved with a threaded rod, and two ends of the threaded rod is rotatably connected to a bearing block. The surface of the threaded rod is fixedly connected with a limiting block, and a threaded block on a surface of the threaded rod is screwed directly above the limiting block. One end of the threaded block is fixedly connected with a supporting plate. A sliding slot is formed in the inner side of the frame, and a sliding block is slidably connected to the inner side of the sliding slot. One end of the sliding block is fixedly connected with a casing, and an inner wall of the casing is fixedly connected with a bump. The surface of the bump is movably fastened with a cleaning sheet. The top of the cleaning head is movably connected with a top head, and the top end of the top head is movably coupled with a top cover. The inside of the top cover is fixedly connected with a gasket, and the surface of the top head is fixedly connected with a chuck.

Preferably, the rotary knob has a hollow structure, and the surface of the rotary knob is provided with a non-slip pattern.

Preferably, the number of the supporting plates is two, and the two support plates are respectively disposed on two sides of the inside of the frame.

Preferably, the surface of the top cover is provided with a hole corresponding to the top head, and the hole is located at a center line position of the top cover.

Preferably, the surface of the casing is provided with a groove, and the groove is engaged with the chuck.

Preferably, the casing has a hollow structure, and the top head penetrates through the top cover and extends to the outside by two centimeters.

The present invention provides a cleaning device for mobile phone screen which provides the following technical effect compared to prior art.

1. The cleaning device for the mobile phone screen is provided with a rotary knob and a bevel gear, and the rotary knob is rotated to drive the bevel gear so that the supporting plate can moves up and down. The position between the supporting plate and the cleaning sheet is located in accordance with the different thickness of the mobile phone, and the transmission is stable and precise. And it is possible to clean the screens of different sizes of mobile phones, thereby achieving a wide range of applications.

2. The cleaning device for the mobile phone screen is provided with the top head and the chuck. The top head pushes out from the cleaning sheet and the chuck to fix the cleaning sheet. It also facilitates to replace cleaning sheet. Two sides of the cleaning sheet can be used for cleaning. It has good cleaning effect, thus achieving the purpose of easy replacement of the cleaning sheet.

### BRIEF DESCRIPTION OF THE DRAWINGS

The invention is illustrated by the following figures and embodiments.

FIG. 1 shows a schematic diagram of the inside of a frame in accordance with an example embodiment.

FIG. 2 shows a schematic diagram of the present invention.

FIG. 3 shows a side view of a casing of the present invention.

The reference numbers of the figures are as follows:

1: frame; 2: bracket; 3: bearing sleeve; 4: rotating shaft; 5: rotary knob; 6: bevel gear; 7: threaded rod; 8: bearing block; 9: limiting block; 10: threaded block; 11: supporting plate; 12: sliding slot; 13: sliding block; 14: casing; 15: bump; 16: cleaning sheet; 17: top head; 18: top cover; 19: gasket; 20: chuck.

### DETAILED DESCRIPTION

The invention is illustrated in accordance with figures. The figures as simplified diagrams demonstrate the basic structures of the apparatus of embodiments of the invention. Thus, the invention is not limited to the figures.

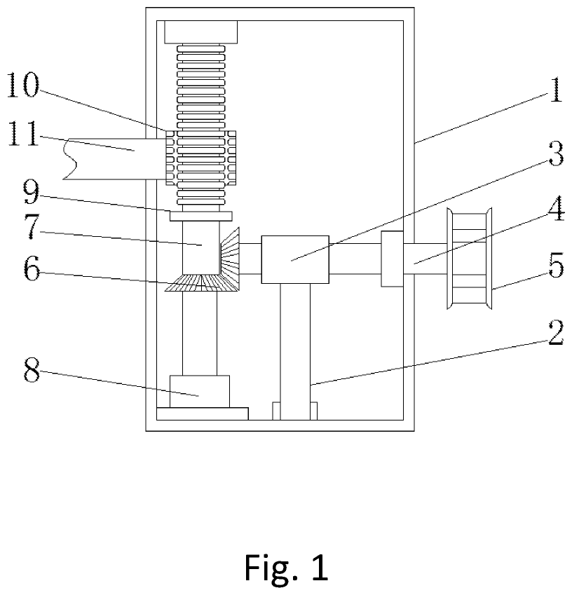

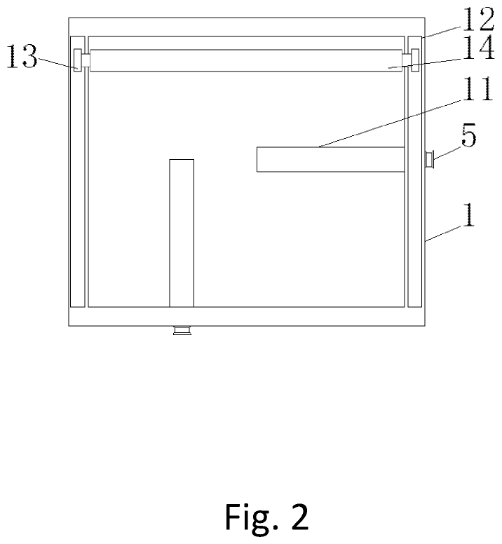

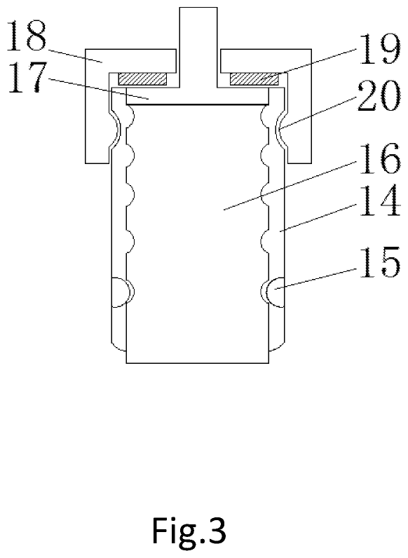

Referring to FIGS. 1-3, a cleaning device for a mobile phone screen includes a frame 1. The inner side of the frame 1 is fixedly connected with a bracket 2. The top end of the bracket 2 is fixedly connected with a bearing sleeve 3. The inner side of the bearing sleeve 3 is rotatably connected with a rotating shaft 4, and one end of the rotating shaft 4 is fixedly connected with a rotary knob 5. One end of the rotating shaft 4 is fixedly connected with a bevel gear 6. The inner side of the bevel bear 6 is fixedly sleeved with a threaded rod 7, and two ends of the threaded rod 7 is rotatably connected to a bearing block 8. The surface of the threaded rod 7 is fixedly connected with a limiting block 9, and a threaded block 10 on a surface of the threaded rod 7 is screwed directly above the limiting block 9. One end of the threaded block 10 is fixedly connected with a supporting plate 11. The cleaning device for the mobile phone screen is provided with a rotary knob 5 and a bevel gear 6, and the rotary knob 5 is rotated to drive the bevel gear 6 so that the supporting plate 11 can moves up and down. The position between the supporting plate 11 and the cleaning sheet 16 is located in accordance with the different thickness of the mobile phone, and the transmission is stable and precise. And it is possible to clean the screens of different sizes of mobile phones, thereby achieving a wide range of applications. The number of the supporting plates is two, and the two support plates are respectively disposed on two sides of the inside of the frame. A sliding slot 12 is formed in the inner side of the frame 1, and a sliding block 13 is slidably connected to the inner side of the sliding slot 12. One end of the sliding block 13 is fixedly connected with a casing 14, and an inner wall of the casing 14 is fixedly connected with a bump 15. The surface of the bump 15 is movably fastened with a cleaning sheet 16. The top of the cleaning head is movably connected with a top head 17, and the top end of the top head 17 is movably coupled with a top cover 18. The surface of the top cover 18 is provided with a hole corresponding to the top head 17, and the hole is located at a center line position of the top cover 18. The casing 14 has a hollow structure, and the top head 17 penetrates through the top cover 18 and extends to the outside by two centimeters. The inside of the top cover 18 is fixedly connected with a gasket 19, and the surface of the top head 18 is fixedly connected with a chuck 20. The surface of the casing 14 is provided with a groove, and the groove is engaged with the chuck 20. The cleaning device for the mobile phone screen is provided with the top head 17 and the chuck 20. The top head 17 pushes out from the cleaning sheet 16 and the chuck 20 to fix the cleaning sheet 16. It also facilitates to replace cleaning sheet 16. Two sides of the cleaning sheet 16 can be used for cleaning. It has good cleaning effect, thus achieving the purpose of easy replacement of the cleaning sheet.

In use, the mobile phone is placed on the support plate 11, and then the rotary knob 5 is rotated, so that the rotary knob 5 rotates the rotating shaft 4 to drive the bevel gear 6 to rotate the threaded rod 7. The threaded block 10 rotates while the threaded rod 7 rotates. The threaded block 10 drives the supporting plate 11 to lift and lower, and then positions the distance according to the thickness of the mobile phone. At the same time, the cleaning sheet 16 inside the casing 14 can be used for cleaning on the screen of the mobile phone, and at the same time, after the cleaning sheet 16 is cleaned, the top head 17 can be removed. The top cover 18 is exchanged for the other side or replaced with a new cleaning sheet 16.

The cleaning device for mobile phone screen has the advantages of wide application and easy replacement, which solves the problem of poor effect of existing cleaning devices.

It should be noted that, in this context, relational terms such as first and second are used merely to distinguish one entity or operation from another entity or operation, and do not necessarily require or imply these entities or operations. There is any such actual relationship or order between them. Furthermore, the term “comprises” or “comprises” or “comprises” or any other variations thereof is intended to encompass a non-exclusive inclusion, such that a process, method, article, or device that comprises a plurality of elements includes not only those elements but also Other elements, or elements that are inherent to such a process, method, item, or device.

The exemplary embodiments of the present invention are thus fully described. Although the description referred to particular embodiments, it will be clear to one skilled in the art that the present invention may be practiced with variations of these specific details. Hence this invention should not be construed as limited to the embodiments set forth herein.

What is claimed is:

1. A cleaning device for a mobile phone screen, comprising: a frame 1, wherein the inner side of the frame 1 is fixedly connected with a bracket 2; the top end of the bracket 2 is fixedly connected with a bearing sleeve 3; the inner side of the bearing sleeve 3 is rotatably connected with a rotating shaft 4, and one end of the rotating shaft 4 is fixedly connected with a rotary knob 5; one end of the rotating shaft 4 is fixedly connected with a bevel gear 6; the inner side of the bevel bear 6 is fixedly sleeved with a threaded rod 7, and two ends of the threaded rod 7 is rotatably connected to a bearing block 8; the surface of the threaded rod 7 is fixedly connected with a limiting block 9, and a threaded block 10 on a surface of the threaded rod 7 is screwed directly above the limiting block 9; one end of the threaded block 10 is fixedly connected with a supporting plate 11; a sliding slot 12 is formed in the inner side of the frame 1, and a sliding block 13 is slidably connected to the inner side of the sliding slot 12; one end of the sliding block 13 is fixedly connected with a casing 14, and an inner wall of the casing 14 is fixedly connected with a bump 15; the surface of the bump 15 is movably fastened with a cleaning sheet 16; the top of the cleaning head 16 is movably connected with a top head 17, and the top end of the top head 17 is movably coupled with a top cover 18; the inside of the top cover 18 is fixedly connected with a gasket 19, and the surface of the top head 18 is fixedly connected with a chuck 20.

2. The cleaning device for a mobile phone screen of claim 1, wherein the rotary knob 5 has a hollow structure, and the surface of the rotary knob 5 is provided with a non-slip pattern.

3. The cleaning device for a mobile phone screen of claim 1, wherein the number of the supporting plates 11 is two, and the two support plates 11 are respectively disposed on two sides of the inside of the frame 1.

4. The cleaning device for a mobile phone screen of claim 1, wherein the surface of the top cover 18 is provided with a hole corresponding to the top head 17, and the hole is located at a center line position of the top cover 18.

5. The cleaning device for a mobile phone screen of claim 1, wherein the surface of the casing 14 is provided with a groove, and the groove is engaged with the chuck 20.

6. The cleaning device for a mobile phone screen of claim 1, wherein the casing 14 has a hollow structure, and the top head 17 penetrates through the top cover 18 and extends to the outside by two centimeters.
